(19) United States
(12) Patent Application Publication
(10) Pub. No.: US 2023/0190413 A1
(43) Pub. Date: Jun. 22, 2023

(54) CONVERSION APPLIANCE FOR ORTHODONTIC TREATMENT

(71) Applicant: Align Technology, Inc., San Jose, CA (US)

(72) Inventors: Ruslan MATVIENKO, Moscow (RU); Maria VAKHNOVETSKAYA, Moscow (RU); Dmitriy Konstantinovich TEN, Novosibirsk (RU); Dmitry PETUNIN, Novosibirsk (RU); Mitra DERAKHSHAN, Herndon, VA (US)

(21) Appl. No.: 18/068,462

(22) Filed: Dec. 19, 2022

Related U.S. Application Data
(60) Provisional application No. 63/291,337, filed on Dec. 17, 2021.

(51) Int. Cl. A61C 7/08

(52) U.S. Cl. CPC A61C 7/08

(57) ABSTRACT

Apparatuses (e.g., systems and devices, including dental appliances and series of dental appliances) that may include one or more conversion appliances that may be worn on a subject’s during a treatment plan without applying substantial orthodontic forces on the subject’s teeth. The conversion appliances described herein may be configured to provide the user with a similar feel as a dental appliance. In some cases these appliances are not part of the dental treatment plan but are added between one or more stages. The dental professional may include one or more conversion appliances between one or more stages of a dental treatment plan, and conversion appliances may be added after the dental treatment plan has been finalized.

### CLAIM OF PRIORITY

This patent application claims priority to U.S. Provisional Pat. Application No. 63/291,337, titled “CONVERSION APPLIANCE FOR ORTHODONTIC TREATMENT,” filed on Dec. 17, 2021 and herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Orthodontic treatment for a patient may include a series of aligners or other orthodontic appliances that the patient may wear throughout the treatment. The treatment may include various stages of tooth movement, with corresponding aligners that the patient may wear during each successive stage to incrementally move the patient’s teeth towards a desired final arrangement.

The patient may experience some discomfort wearing aligners because moving the teeth may involve the aligners applying pressure to the teeth, which in turn may apply pressure to other connected structures in the patient’s mouth and jaw. Certain stages, such as initial stages, may be particularly uncomfortable as the patient may experience pressure from the aligner that they are not accustomed to. For example, the patient may be uncomfortable when wearing the first aligner for the first stage of treatment as the patient may not be used to wearing any appliance. As another example, wearing an appliance on one arch to move teeth of that arch, while the teeth of the other arch do not have an appliance because those teeth do not move, may be uncomfortable.

Although a primer appliance may be used at the beginning of primary treatment and a retainer used after treatment, such appliances may not be easily integrated into the treatment planning workflow or may otherwise not provide enough of a transition period for the patient. For example, such appliances may be made of different material from aligners, requiring different fabrication workflow. In addition, such appliances may not be as customizable as needed, for instance with respect to placement within the treatment plan as well as allowing for attachments and other aligner features and auxiliary components.

Thus, the present disclosure provides for customizable conversion aligners. The methods and apparatuses described herein may improve treatment planning, as well as improve the patient’s experience during treatment.

### SUMMARY OF THE DISCLOSURE

As described in greater detail below, the present disclosure describes various systems and methods for designing and fabricating systems and devices, including conversion appliances, for orthodontic treatment. In addition, the apparatuses (e.g., systems and devices) and methods described herein may improve earlier systems and methods, including improving the functioning of a computing device, by reducing computing resources and overhead for treatment planning and allowing more flexibility for transitional stages, thereby improving processing efficiency of the computing device. These systems and methods may also improve the field of orthodontic treatment by allowing for customized transitional stages and improving the patient’s experience during treatment.

Thus, described herein are apparatuses (e.g., systems and devices, including dental appliances and series of dental appliances) that may include one or more conversion appliances that may be worn on a subject’s during a treatment plan without applying substantial orthodontic forces on the subject’s (e.g., patient’s) teeth. The conversion appliances described herein may be configured to provide the user with a similar feel as a dental appliance. In some cases these appliances are not part of the dental treatment plan, but are added between one or more stages. The user (e.g., dentist, orthodontist, dental practitioner, etc.) may include one or more conversion appliances between one or more stages of a dental treatment plan; the conversion appliances may be added after the dental treatment plan has been finalized. In general, the conversion appliance does not provide significant active force on the subject’s teeth, but merely remains in position.

A treatment plan may typically include a series of dental appliances (e.g., aligners, including “shell aligners”) formed of a material, such as polymeric material, including a channel for seating and securing teeth, which may be worn over the subject’s teeth. These dental appliances are customized to the patient’s teeth and may also be worn in conjunction with attachments that may couple the subject’s teeth to the dental appliance. Any of the conversion appliances described herein may be structured similar to the dental appliances forming the treatment plan, or they may be different. These dental appliances may include attachment coupling regions that may couple with one or more attachments on the subject’s teeth. In some examples the conversion appliance may be configured to be worn more ‘loosely’ than then dental appliance. For example, the attachment regions may be configured to cover, but not engage with, e.g., not apply force to, or not apply force greater than a threshold (e.g., 0.1 N, 0.2 N, 0.3 N, 0.4 N, 0.5 N, 0.6 N, 0.7 N, etc., such as bout 0.5 N) to an attachment and/or tooth. In some examples, the conversion appliance may be configured so that, when part of a series of dental aligners, the space forming the tooth engagement region, in which the subject’s teeth fit, has a larger average diameter than the average diameter of the other force-applying aligners in the series of dental aligners (in the treatment plan).

For example, described herein are systems, e.g., orthodontic treatment systems, comprising a series of appliances, the series of appliances comprising: a series of shell aligner appliances configured to be sequentially worn on a patient’s teeth to incrementally move a patient’s teeth from an initial tooth arrangement to a target tooth arrangement, further wherein each shell aligner appliance of the series of shell aligner appliances comprises a plurality of tooth-receiving cavities configured to hold the patient’s teeth and to apply a force to one or more of the patient’s teeth to move one or more of the patient’s teeth; and one or more shell conversion appliances configured to worn as either a first appliance in the series of appliances or as an intermediate appliance in the series of appliances, wherein the one or more conversion shell appliances comprises a plurality of tooth-receiving cavities configured to hold the patient’s teeth without moving the patient’s teeth.

The one or more shell conversion appliances may be configured to be worn as intermediate appliance in the series of appliances. The one or more shell conversion appliances may be formed of a different material than the shell aligner appliances of the series of shell aligner appliances. For example, the shell conversion appliances may be formed of a more flexible material than the shell aligner appliances of the same system.

In general, the shell conversion appliances (which may be referred to herein equivalently as conversion appliances or conversion devices) may be configured to have a larger opening for fitting onto or over the patient’s teeth. For example, as mentioned above, the plurality of tooth-receiving cavities of the one or more shell conversion appliances may have an average volume that is greater than an average volume of the plurality of tooth-receiving cavities of any of the shell aligner appliances of the series of shell aligner appliances. In general, the plurality of tooth-receiving cavities of the one or more shell conversion appliances may be configured to be more loosely fitting to the patient’s teeth than the plurality of tooth-receiving cavities of the shell aligner appliances of the series of shell aligner appliances. In some examples in which the shell conversion appliance is more loosely fitted over the patient’s teeth the shell conversion appliances may also include one or more attachments for securing the shell conversion appliance to the patient’s teeth via the one or more attachments to prevent it from disengaging from the teeth.

In any of these examples the shell conversion appliance may be thinner, e.g., in all or a region of the tooth-receiving cavity, than the shell aligner appliances of the series of apparatuses. For example, the plurality of tooth-receiving cavities of the one or more shell conversion appliances may have an average wall thickness that is less than the average wall thickness of the plurality of tooth-receiving cavities of the shell aligner appliances of the series of shell aligner appliances. In some examples, the plurality of tooth-receiving cavities of the one or more shell conversion appliances may have buccal and lingual sidewalls and the plurality of tooth-receiving cavities of the shell aligner appliances of the series of shell aligner appliances may have buccal and lingual sidewalls, and either or both the buccal and/or lingual sidewalls may have be thicker in the shell aligner appliances as compared to the tooth-receiving cavities. In some examples the average thickness of the buccal and lingual sidewalls of the shell conversion appliances is less than the average thickness of the buccal and lingual sidewalls of the shell aligner appliances of the series of shell aligner appliances.

In general, the shell aligner appliances of a system (e.g., of a series of shell aligner appliances) may have at least one of: pontics, attachment receiving wells, hooks, or precision cuts; in some examples, the one or more shell conversion appliances do not include pontics, attachment receiving wells, hooks, or precision cuts. In some examples the one or more shell conversion appliances do include pontics, attachment receiving wells, hooks, or precision cuts.

In any of the method and apparatuses described herein each appliance of a series of appliances (e.g., shell aligner apparatuses and/or shell conversion appliances) may be configured to be worn for more than a day (e.g., 2 days or more, 3 days or more, 4 days or more, 5 days or more, 6 days or more, 7 days or more, 1.5 weeks or more, 2 weeks or more, etc.). In general, the appliances may be configured to be applied and/or withdrawn or removed by the patient. For example, the appliances of the series of appliances may be configured to be worn for more than 3 days before wearing the next appliance of the series of appliances.

In general any of these systems and methods may include either just a series of upper arch appliances, just a series of lower arch appliances, or a series of both upper and lower arch appliances that are configured to be worn together (so that the patient is wearing both an upper and lower arch appliance). For example, a series of appliances (including a sequence of both shell aligner appliances configured to move the teeth intermixed with one or more shell conversion appliances configured to not significantly move the teeth, e.g., by applying less than a dental movement threshold for moving the teeth) may be configured to be worn on the patient’s upper arch, and may further comprising a second series of appliances configured to be worn on the patient’s lower arch, wherein the second series of appliances comprises a second series of shell aligner appliances and a second one or more shell conversion appliances. The second one or more shell conversion appliances may correspond to a different position in the second series of appliances than a position of the one or more shell conversion appliances in the series of appliances.

Also described herein are methods of making and/or using any of these apparatuses. For example, described herein are methods comprising: receiving a dental treatment plan comprising a plurality of treatment stages, wherein each stage comprises a shell aligner appliance configured to be sequentially worn in a specified treatment stage of the dental treatment plan, wherein each shell aligner appliance is configured to exert a force on one or more of the patient’s teeth in order to move the patient’s dentition from an initial arrangement towards a final arrangement; generating a conversion appliance stage comprising a shell conversion appliance; inserting the conversion appliance stage into the dental treatment plan to generate a modified dental treatment plan wherein the conversion appliance stage is between two treatment stages of the dental treatment plan, further wherein the shell conversion appliance is configured to exert a force of less than a dental movement threshold on the patient’s teeth when worn on the patient’s teeth so that the patient’s teeth remain substantially unchanged for the conversion appliance stage; and sending the modified dental treatment plan to a dental professional for review.

Any of these methods may include transmitting the modified dental treatment plan for fabrication to form a series of dental appliances based on the dental treatment plan and including the shell aligner appliances and the conversion dental aligner. In some examples, the method may include receiving instructions from a dental professional indicating at which stage in the dental treatment plan to insert the conversion appliance stage.

In any of these method and apparatuses the dental movement threshold may be, e.g., 0.7 N or less (e.g., 0.6 N, 0.55 N, 0.5 N, 0.45 N, 0.4 N, 0.35 N, 0.3 N, 0.25 N, 0.2 N, etc.). For example, the dental movement threshold may be 0.5 N. As mentioned, in any of these methods and apparatuses the shell conversion appliances may be configured so that only forces less than the dental movement threshold are applied to the teeth. In contrast, the shell aligner appliances (which may be equivalently referred to herein as shell aligner appliances, shell aligners, aligner appliances or simply “aligners”), may generally apply a force greater than the dental movement threshold to one or more teeth when worn by the patient. Thus, in general, a shell aligner appliance of the dental treatment plan is configured to exert more than the dental movement threshold force on one or more of the patient’s teeth.

A shell conversion appliance may have a configuration that is substantially the same as a dental aligner corresponding to a stage of the dental treatment plan immediate before the conversion appliance stage in the modified dental treatment plan. Any of these methods may include configuring the shell conversion appliance to include any of the features described herein that may allow it to exert less force than the dental movement threshold. For example, any of these methods may include configuring the shell conversion appliance to be formed of a different material (e.g., a more flexible material) than the material of the shell aligner appliances, at least in all or portion of the tooth receiving cavities. For example, the method may include configuring the shell conversion appliance to have an average volume for the tooth-receiving cavities that is greater than an average volume of a plurality of tooth-receiving cavities of any of the shell aligner appliances. Any of these methods may include configuring the shell conversion appliance so that the shell aligner appliance comprises a plurality of tooth-receiving cavities that are configured to be more loosely fitting to the patient’s teeth than a plurality of tooth-receiving cavities of any of the shell aligner appliances. Any of these methods may include configuring the shell aligner appliance to include a plurality of tooth-receiving cavities having an average wall thickness that is less than an average wall thickness of the plurality of tooth-receiving cavities of any of the shell aligner appliances. Any of these methods may include configuring the shell conversion appliance to have buccal and lingual sidewalls having an average thickness that is less than the average thickness of buccal and lingual sidewalls of any of the shell aligner appliances. Any of these methods may include configuring the shell aligner appliances to include at least one of: pontics, attachment receiving wells, hooks, or precision cuts, and in some examples configuring the shell conversion appliance to not include pontics, attachment receiving wells, hooks, or precision cuts.

Also described herein are non-transitory computing device readable medium having instructions stored thereon that are executable by a processor to cause a computing device to perform any of the methods described herein. For example, described herein are non-transitory computing device readable medium having instructions stored thereon that are executable by a processor to cause a computing device to perform the method of: receiving a dental treatment plan comprising a plurality of treatment stages, wherein each stage comprises a shell aligner appliance configured to be sequentially worn in a specified treatment stage of the dental treatment plan, wherein each shell aligner appliance is configured to exert a force on one or more of the patient’s teeth in order to move the patient’s dentition from an initial arrangement towards a final arrangement; generating a conversion appliance stage comprising a shell conversion appliance; inserting the conversion appliance stage into the dental treatment plan to generate a modified dental treatment plan wherein the conversion appliance stage is between two treatment stages of the dental treatment plan, further wherein the shell conversion appliance is configured to exert a force of less than a dental movement threshold on the patient’s teeth when worn on the patient’s teeth so that the patient’s teeth remain substantially unchanged for the conversion appliance stage; and sending the modified dental treatment plan to a dental professional for review.

Also described herein are orthodontic treatment system comprising: a plurality of pairs orthodontic appliances, each of the pairs of orthodontic appliances being for a stage of an orthodontic treatment plan to move a patient’s teeth from a first arrangement towards a second arrangement: a first pair of appliances for a first stage of an orthodontic treatment plan, the first pair of appliances comprising: a first appliance for a first arch of the patient; and a second appliance for a second arch of the patient, each of the first and second appliances comprising tooth receiving cavities; and a second pair of appliances for a second stage of an orthodontic treatment plan, the second pair of appliances comprising: a third appliance for the first arch of the patient; and a fourth appliance for the second arch of the patient, each of the third and fourth appliances comprising tooth receiving cavities; and wherein the tooth receiving cavities of at least one of the first pair of appliances for the first stage of the orthodontic treatment plan are shaped to be worn by the patient without moving the patient’s teeth and the tooth receiving cavities of at least one of the second pair of appliances for the second stage of the orthodontic treatment plan are shaped to move the patient’s teeth when worn by the patient.

The first appliance and the second appliance of the first pair of appliances for the first stage of the orthodontic treatment plan may both be shaped to be worn by the patient without moving the patient’s teeth. The third appliance and the fourth appliance of the second pair of appliances for the second stage of the orthodontic treatment plan may both be shaped to move the patient’s teeth when worn by the patient. The first appliance and the second appliance of the first pair of appliances for the first stage of the orthodontic treatment plan may both be shaped to be worn by the patient without moving the patient’s teeth; and the third appliance and the fourth appliance of the second pair of appliances for the second stage of the orthodontic treatment plan are both shaped to move the patient’s teeth when worn by the patient.

The tooth receiving cavities of the first pair of appliances may have buccal and lingual sidewalls defining at least a portion of the tooth receiving cavities; the sidewalls may have a thickness that is similar to a thickness of sidewalls of the tooth receiving cavities of the second pair of appliances. The first pair of appliances may be for an initial stage of treatment. In some examples, the first pair of appliances are for a final stage of treatment. In some examples the first pair of appliances are for an intermediate stage of treatment. The system of claim 1, further comprising: a third pair of appliances for a third stage of an orthodontic treatment plan, the third pair of appliances comprising: a fifth appliance for the first arch of the patient; and a sixth appliance for the second arch of the patient, each of the fifth and sixth appliances comprising tooth receiving cavities, wherein the tooth receiving cavities of at least one of the third pair of appliances for the third stage of the orthodontic treatment plan are shaped to be worn by the patient without moving the patient’s teeth. The first appliance and the second appliance of the first pair of appliances for the first stage of the orthodontic treatment plan may include at least one of pontics, attachment receiving wells, hooks, or precision cuts formed in the first appliance and the second appliance.

Also described herein are methods, including methods for orthodontically treating a patient’s teeth. For example, a method may include: receiving a three-dimensional model of a patient’s dentition in an initial arrangement; determining a final arrangement of the patient’s dentition based on the three-dimensional model of a patient’s dentition; generating tooth movement paths to move the patient’s teeth from the initial arrangement towards the final arrangement in a series of tooth movement stages; generating a conversion appliance stage, wherein at least one arch of the patient’s dentition remains substantially unchanged for the conversion appliance stage; and sending an orthodontic treatment plan comprising the series of tooth movement stages and the conversion appliance stage to a dental professional for review.

Any of these methods may also include fabricating a series of dental appliances based on an orthodontic treatment plan (or modified orthodontic treatment plan) and may include at least one conversion appliance for the conversion appliance stage and a plurality of appliances for the series of tooth movement stages.

Any of these methods may include generating at least one of pontics, attachment receiving wells, hooks, or precision cuts for the conversion appliance stage. The conversion appliance stage may include generating an arrangement of the patient’s dentition for the conversion appliance stage.

Any of these methods may include generating an initial treatment plan, modifying the treatment plan (e.g., to include one or more conversion appliances), and/or generating tooth movements paths to move the patient’s teeth from the initial arrangement towards the final arrangement in a series of tooth movement stages comprises generating a three-dimensional model based on the patient’s dentition for each of the series of tooth movement stages.

For example, any of these methods may include generating one or more (e.g., a plurality of) conversion appliance stages after the patient’s teeth of a first arch have completed movement towards the final arrangement, wherein the patient’s dentition of the first arch remains substantially unchanged. The patient’s teeth of a second arch may move towards the final arrangement during the plurality of conversation appliance stages. Any of these methods may include generating a plurality of conversion appliance stages after the patient’s teeth of the first arch and the second arch have completed movement towards the final arrangement, wherein the patient’s dentition of the first arch and second arch remains substantially unchanged.

The tooth movements paths may include an anterior-posterior correction of at least 4 mm.

Any of these methods may include determining whether to generate a conversion appliance stage, based on one or more characteristics, the characteristics including at least one of a country of the patient, a doctor treating the patient, or a number of tooth movement stages.

Described herein are methods of generating a treatment plan for orthodontically treating a patient’s teeth. For example, the method may include: receiving a treatment plan comprising a series of dental aligners configured to be sequentially worn in a treatment stage of the treatment plan, wherein each dental aligner of the series of dental aligners is configured to exert a force on one or more of the patient’s teeth in order to move the patient’s dentition from an initial arrangement to a final arrangement; generating a conversion appliance stage comprising a conversion dental aligner; inserting the conversion appliance stage into the dental treatment plan to generate a modified dental treatment plan wherein the conversion appliance stage is between two stages of the dental treatment plan, further wherein the conversion dental aligner is configured not to exert a force greater than a dental movement threshold on the patient’s teeth when worn on the patient’s teeth so that the patient’s teeth remain substantially unchanged for the conversion appliance stage; and transmitting the modified orthodontic treatment plan for fabrication to form the series of dental aligners including the conversion dental aligner.

Any of these methods may include receiving instructions from a dental professional indicating where in the dental treatment plan to insert the conversion appliance stage. For example, the dental movement threshold may be 0.7 N, 0.6 N, 0.5 N, 0.45 N, 0.4 N, 0.35 N, 0.3 N, 0.25 N, 0.2 N, 0.1 N, etc. In some examples each dental aligner of the series of dental aligners may be configured to exert more than the dental movement threshold force on one or more of the patient’s teeth. The conversion dental aligner may have a configuration that is substantially the same as the dental aligner of the stage of the treatment plan immediate before the conversion appliance stage in the modified orthodontic treatment plan.

Also described herein are systems and software (e.g., non-transitory, computer readable media having instruction for performing some or all of the methods). In particular, described herein are non-transitory computing device readable medium having instructions stored thereon that are executable by a processor to cause a computing device to perform the method of: receiving a treatment plan comprising a series of dental aligners configured to be sequentially worn in a treatment stage of the treatment plan, wherein each dental aligner of the series of dental aligners is configured to exert a force on one or more of the patient’s teeth in order to move the patient’s dentition from an initial arrangement to a final arrangement; generating a conversion appliance stage comprising a conversion dental aligner; inserting the conversion appliance stage into the dental treatment plan to generate a modified dental treatment plan wherein the conversion appliance stage is between two stages of the dental treatment plan, further wherein the conversion dental aligner is configured not to exert a force greater than a dental movement threshold on the patient’s teeth when worn on the patient’s teeth so that the patient’s teeth remain substantially unchanged for the conversion appliance stage; and transmitting the modified orthodontic treatment plan for fabrication to form the series of dental aligners including the conversion dental aligner.

A system may include: one or more processors; a memory coupled to the one or more processors, the memory configured to store computer-program instructions, that, when executed by the one or more processors, perform a computer-implemented method comprising: receiving a treatment plan comprising a series of dental aligners configured to be sequentially worn in a treatment stage of the treatment plan, wherein each dental aligner of the series of dental aligners is configured to exert a force on one or more of the patient’s teeth in order to move the patient’s dentition from an initial arrangement to a final arrangement; generating a conversion appliance stage comprising a conversion dental aligner; inserting the conversion appliance stage into the dental treatment plan to generate a modified dental treatment plan wherein the conversion appliance stage is between two stages of the dental treatment plan, further wherein the conversion dental aligner is configured not to exert a force greater than a dental movement threshold on the patient’s teeth when worn on the patient’s teeth so that the patient’s teeth remain substantially unchanged for the conversion appliance stage; and transmitting the modified orthodontic treatment plan for fabrication to form the series of dental aligners including the conversion dental aligner.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1A illustrates an exemplary tooth repositioning appliance or aligner (e.g., “shell aligner”) that can be worn by a patient in order to achieve an incremental repositioning of individual teeth in the jaw, in accordance with some embodiments.

FIG. 1B illustrates a tooth repositioning system, in accordance with some embodiments.

FIG. 2 shows a method of orthodontic treatment using a plurality of appliances, in accordance with embodiments.

FIG. 3 shows a method for digitally planning an orthodontic treatment, in accordance with embodiments.

FIG. 4 shows a simplified block diagram of a data processing system, in accordance with embodiments.

FIG. 5 shows a method for digitally planning an orthodontic treatment including a conversion appliance, in accordance with embodiments.

### DETAILED DESCRIPTION

Described herein are appliances (e.g., devices and systems) and methods that include one or more shell conversion appliances that is configured to be worn on the patients teeth but not apply sufficient force to move the teeth. The shell conversion appliance may be included as part of a series of appliances including a plurality of shell aligner appliances that are configured to move one or more teeth when worn. The shell conversion appliances and the shell aligner appliances may be otherwise similar. As used herein a shell conversion appliances may be referred to equivalently as a shell conversion device, conversion device or conversion aligner. As used herein a shell aligner appliance may be referred to equivalently as an aligner appliance, aligner device or simply an aligner.

In some examples the apparatuses described herein includes a series of appliances comprising: a series of shell aligner appliances configured to be sequentially worn on a patient’s teeth to incrementally move a patient’s teeth from an initial tooth arrangement to a target tooth arrangement and one or more shell conversion appliances configured to worn as either a first appliance in the series of appliances or as an intermediate appliance in the series of appliances. The shell aligner appliances of the series of appliances may include a plurality of tooth-receiving cavities configured to hold the patient’s teeth and to apply a force to one or more of the patient’s teeth to move one or more of the patient’s teeth. The one or more conversion shell appliances may comprise a plurality of tooth-receiving cavities configured to hold the patient’s teeth without moving the patient’s teeth.

In general, the shell conversion appliances may be configured to be worn as intermediate appliance in the series of appliances. The shell conversion appliances may be formed of a different material than the shell aligner appliances of the series of shell aligner appliances. For example, the shell conversion appliances may be formed of a more flexible material than the shell aligner appliances of the same system.

In general, the shell conversion appliances (which may be referred to herein equivalently as conversion appliances or conversion devices) may be configured to have a larger opening for fitting onto or over the patient’s teeth. For example, as mentioned above, the plurality of tooth-receiving cavities of the one or more shell conversion appliances may have an average volume that is greater than an average volume of the plurality of tooth-receiving cavities of any of the shell aligner appliances of the series of shell aligner appliances. In general, the plurality of tooth-receiving cavities of the one or more shell conversion appliances may be configured to be more loosely fitting to the patient’s teeth than the plurality of tooth-receiving cavities of the shell aligner appliances of the series of shell aligner appliances. In some examples in which the shell conversion appliance is more loosely fitted over the patient’s teeth the shell conversion appliances may also include one or more attachments for securing the shell conversion appliance to the patient’s teeth via the one or more attachments to prevent it from disengaging from the teeth.

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

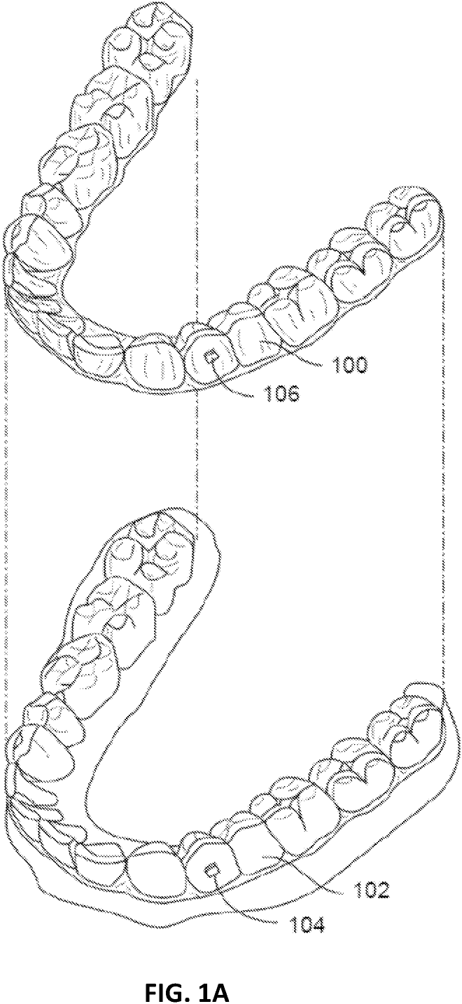

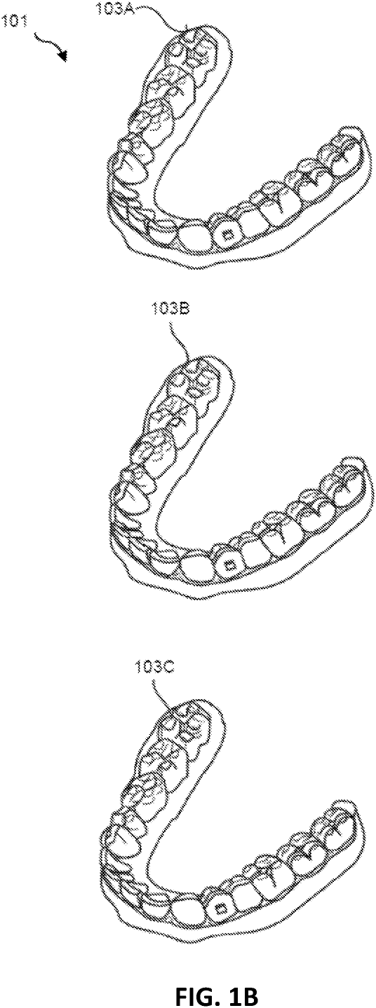

FIG. 1A illustrates an exemplary shell conversion appliance 100 that can be worn by a patient and that does not move teeth or an aligner that can be worn by a patient as part of a series of appliances to achieve an incremental repositioning of individual teeth 102 in the jaw. The appliance can include a shell (e.g., a continuous polymeric shell or a segmented shell) having teeth-receiving cavities that receive and resiliently reposition the teeth. An appliance or portion(s) thereof may be indirectly fabricated using a physical and/or digital model of teeth. For example, an appliance (e.g., polymeric appliance) can be formed using a physical model of teeth and a sheet of suitable layers of polymeric material. The physical model (e.g., physical mold) of teeth can be formed through a variety of techniques, including 3D printing. The appliance can be formed by thermoforming the appliance over the physical model. In some embodiments, a physical appliance is directly fabricated, e.g., using additive manufacturing techniques, from a digital model of an appliance. In some embodiments, the physical appliance may be created through a variety of direct formation techniques, such as 3D printing. An appliance can fit over all teeth present in an upper or lower jaw, or less than all of the teeth.

The appliance can be designed specifically to accommodate the teeth of the patient (e.g., the topography of the tooth-receiving cavities matches the topography of the patient’s teeth) and may be fabricated based on positive or negative models of the patient’s teeth generated by impression, scanning, and the like. Alternatively, the appliance can be a generic appliance configured to receive the teeth, but not necessarily shaped to match the topography of the patient’s teeth.

In some cases, no teeth of one or both arches may be repositioned during a treatment stage, such as when using a shell aligner appliance in combination with a shell conversion appliance. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. In some embodiments, no wires or other means will be provided for holding an appliance in place over the teeth. In some cases, however, it may be desirable or necessary to provide individual attachments or other anchoring elements 104 on teeth 102 with corresponding receptacles or apertures 106 in the appliance 100 so that the appliance can apply a selected force on the tooth. Exemplary aligner appliances, including those utilized in the Invisalign® System, are described in numerous patents and patent applications assigned to Align Technology, Inc. including, for example, in U.S. Pat. Nos. 6,450,807, and 5,975,893, as well as on the company’s website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 1B illustrates a tooth repositioning system 101 including a plurality of appliances 103A, 103B, 103C. Any of the appliances described herein can be designed and/or provided as part of a set of a plurality of appliances used in a tooth repositioning system. Each appliance may be configured so a tooth-receiving cavity has a geometry corresponding to a conversion stage, wherein teeth of one or both arches may not move, an intermediate stage, or final tooth arrangement intended for the appliance. The patient’s teeth can be progressively repositioned from an initial tooth arrangement to a target tooth arrangement by placing a series of incremental position adjustment appliances over the patient’s teeth. For example, the tooth repositioning system 101 can include a first appliance 103A corresponding to an initial tooth arrangement and which may include a conversation appliance, one or more intermediate appliances 103B corresponding to one or more intermediate arrangements, and a final appliance 103C corresponding to a target arrangement. A target tooth arrangement can be a planned final tooth arrangement selected for the patient’s teeth at the end of all planned orthodontic treatment. Alternatively, a target arrangement can be one of some intermediate arrangements for the patient’s teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient’s teeth that follows one or more incremental repositioning stages. Likewise, an initial tooth arrangement can be any initial arrangement for the patient’s teeth that is followed by one or more incremental repositioning stages.

Optionally, in cases involving more complex movements or treatment plans, it may be beneficial to utilize auxiliary components (e.g., features, accessories, structures, devices, components, and the like) in conjunction with an orthodontic appliance. Examples of such accessories include but are not limited to elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems and methods described herein include improved orthodontic appliances with integrally formed features that are shaped to couple to such auxiliary components, or that replace such auxiliary components.

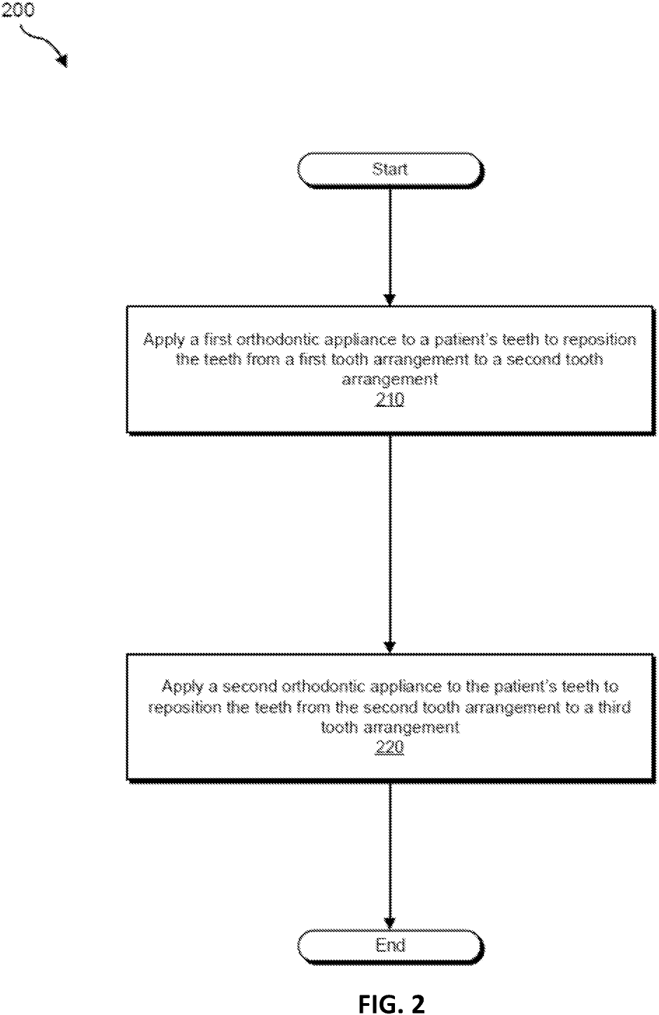

FIG. 2 illustrates a method 200 of orthodontic treatment using a plurality of appliances, in accordance with many embodiments. The method 200 can be practiced using any of the appliances or appliance sets described herein. In step 210, a first orthodontic appliance is applied to a patient’s teeth. The first orthodontic appliance may be a shell conversion appliance that is applied to the patient’s teeth. In some embodiments, the first orthodontic appliance is a shell aligner appliance shaped such that when applied to the patient’s teeth it repositions the teeth from a first tooth arrangement to a second tooth arrangement. In step 220, a second orthodontic appliance is applied to the patient’s teeth in order to reposition the teeth from the second tooth arrangement to a third tooth arrangement. The method 200 can be repeated as necessary using any suitable number and combination of sequential appliances in order to incrementally reposition the patient’s teeth from an initial arrangement to a target arrangement. The appliances can be generated all at the same stage or in sets or batches (e.g., at the beginning of a stage of the treatment), or one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality.

In some examples it may be particularly helpful to include a shell conversion appliance as an intermediate appliance in a series of dental/orthodontic appliances, so that the appliance in the series immediately before and immediately after the shell conversion appliance is a shell aligner appliance. This may allow for a period of repose during treatment that may surprisingly enhance the ability to move and retain position of the (moved) tooth or teeth.

After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

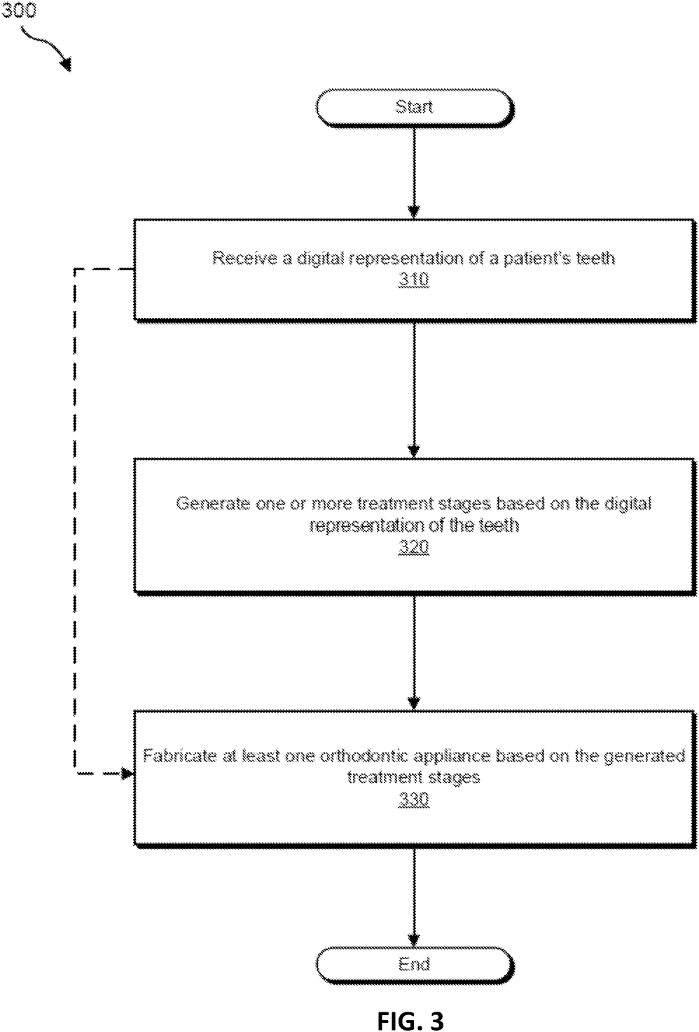

FIG. 3 illustrates a method 300 for digitally planning an orthodontic treatment and/or design or fabrication of an appliance, in accordance with many embodiments. The method 300 can be applied to any of the treatment procedures described herein and can be performed by any suitable data processing system. Any embodiment of the appliances described herein can be designed or fabricated using the method 300.

In step 310, a digital representation of a patient’s teeth is received. The digital representation can include surface topography data for the patient’s intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step 320, one or more treatment stages are generated based on the digital representation of the teeth. The treatment stages can be conversation stages or incremental repositioning stages of an orthodontic treatment procedure designed to move one or more of the patient’s teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 330, at least one orthodontic appliance is fabricated based on the generated treatment stages. For example, a set of appliances can be fabricated to be sequentially worn by the patient as part of a treatment plan to incrementally reposition the teeth from the initial arrangement to the target arrangement. Some of the appliances can be shaped to accommodate a tooth arrangement specified by one of the treatment stages. Alternatively or in combination, some of the appliances can be shaped to accommodate a tooth arrangement that is different from the target arrangement for the corresponding treatment stage. For example, as previously described herein, an appliance may have a geometry corresponding to an overcorrected tooth arrangement. Such an appliance may be used to ensure that a suitable amount of force is expressed on the teeth as they approach or attain their desired target positions for the treatment stage. As another example, an appliance can be designed in order to apply a specified force system on the teeth and may not have a geometry corresponding to any current or planned arrangement of the patient’s teeth.

In some instances, staging of various arrangements or treatment stages may not be necessary for design and/or fabrication of an appliance. As illustrated by the dashed line in FIG. 3, design and/or fabrication of an orthodontic appliance, and perhaps a particular orthodontic treatment, may include use of a representation of the patient’s teeth (e.g., receive a digital representation of the patient’s teeth at 310), followed by design and/or fabrication of an orthodontic appliance based on a representation of the patient’s teeth in the arrangement represented by the received representation.

A “dental consumer,” as used herein, may include a person seeking assessment, diagnosis, and/or treatment for a dental condition (general dental condition, orthodontic condition, endodontic condition, condition requiring restorative dentistry, etc.). A dental consumer may, but need not, have agreed to and/or started treatment for a dental condition. A “dental patient” or “subject” (used interchangeably with patient herein) as used herein, may include a person who has agreed to diagnosis and/or treatment for a dental condition. A dental consumer and/or a dental patient, may, for instance, be interested in and/or have started orthodontic treatment, such as treatment using one or more (e.g., a sequence of) aligners (e.g., polymeric appliances having a plurality of tooth-receiving cavities shaped to successively reposition a person’s teeth from an initial arrangement toward a target arrangement).

A “dental professional” (used interchangeably with dentist, orthodontist, and doctor or generically “user,” herein) as used herein, may include any person with specialized training in the field of dentistry, and may include, without limitation, general practice dentists, orthodontists, dental technicians, dental hygienists, etc. A dental professional may include a person who can assess, diagnose, and/or treat a dental condition. “Assessment” of a dental condition, as used herein, may include an estimation of the existence of a dental condition. An assessment of a dental condition need not be a clinical diagnosis of the dental condition. In some embodiments, an “assessment” of a dental condition may include an “image-based assessment,” that is an assessment of a dental condition based in part or on whole on photos and/or images (e.g., images that are not used to stitch a mesh or form the basis of a clinical scan) taken of the dental condition. A “diagnosis” of a dental condition, as used herein, may include a clinical identification of the nature of an illness or other problem by examination of the symptoms. “Treatment” of a dental condition, as used herein, may include prescription and/or administration of care to address the dental conditions. Examples of treatments to dental conditions include prescription and/or administration of brackets/wires, clear aligners, and/or other appliances to address orthodontic conditions, prescription and/or administration of restorative elements to address bring dentition to functional and/or aesthetic requirements, etc.

The present disclosure provides systems and methods for designing and fabricating a conversion appliance or transition appliance for orthodontic treatment. The systems and methods provided herein may improve the functioning of a computing device by efficiently producing stages of a treatment plan without requiring significantly more data or complex calculations. In addition, the systems and methods provided herein may improve the field of medical care by allowing for the addition of transition periods or stages before, during, and/or after active treatment stages.

A conversion appliance or transition appliance may refer to an orthodontic appliance (e.g., any of appliance 100, 103A, 103B, 103C as described herein) that may not reposition a patient’s teeth. For example, a shell conversion appliance may be configured so that it does not apply a force that is greater than a dental movement threshold, in order to prevent moving the teeth when worn. In contrast the shell aligner appliances described herein may typically apply a force that is greater than the dental movement threshold, in order to move the teeth. A conversion appliance may include a pair of aligners that may be used during orthodontic treatment without any tooth movements on treated arches. A conversion appliance may be placed in any place of a treatment (e.g., before, during, and/or after active treatment stages) one or more times and may further include features on it.

In any of the shell conversion appliances described herein the shell conversion appliance may be configured to prevent moving the teeth when worn by altering one or more properties of the shell conversion appliance relative to a similarly-configured shell aligner apparatus. For example, the shell conversion appliances described herein may be formed of a different material than the shell aligner appliances of the series of shell aligner appliances. In some examples, the shell conversion appliances may be formed of a more flexible material than the shell aligner appliances of the same system. The shell conversion appliances may be entirely formed of a different (e.g., more elastic) material, or it may include a region having different material properties (e.g., elasticity).

In general, the shell conversion appliances may be configured to have a larger tooth receiving regions. For example, as mentioned above, the plurality of tooth-receiving cavities of the one or more shell conversion appliances may have an average volume that is greater than an average volume of the plurality of tooth-receiving cavities of any of the shell aligner appliances of the series of shell aligner appliances. In general, the plurality of tooth-receiving cavities of the one or more shell conversion appliances may be configured to be more loosely fitting to the patient’s teeth than the plurality of tooth-receiving cavities of the shell aligner appliances of the series of shell aligner appliances. In some examples in which the shell conversion appliance is more loosely fitted over the patient’s teeth the shell conversion appliances may also include one or more attachments for securing the shell conversion appliance to the patient’s teeth via the one or more attachments to prevent it from disengaging from the teeth.

The shell conversion appliance may be thinner, e.g., in all or a region of the tooth-receiving cavity, than the shell aligner appliances of the series of apparatuses. For example, the plurality of tooth-receiving cavities of the one or more shell conversion appliances may have an average wall thickness that is less than the average wall thickness of the plurality of tooth-receiving cavities of the shell aligner appliances of the series of shell aligner appliances. In some examples, the plurality of tooth-receiving cavities of the one or more shell conversion appliances may have buccal and lingual sidewalls and the plurality of tooth-receiving cavities of the shell aligner appliances of the series of shell aligner appliances may have buccal and lingual sidewalls, and either or both the buccal and/or lingual sidewalls may have be thicker in the shell aligner appliances as compared to the tooth-receiving cavities. In some examples the average thickness of the buccal and lingual sidewalls of the shell conversion appliances is less than the average thickness of the buccal and lingual sidewalls of the shell aligner appliances of the series of shell aligner appliances. In some examples the shell conversion appliances is 5% thinner than the shell aligner appliance that is part of the same series to be worn (e.g., 7.5% thinner, 10% thinner, 15% thinner, 20% thinner, 25% thinner, etc., in all or a region of the tooth-receiving cavity, as compared to a shell aligner appliance in the same sequence of appliances.

In general, the shell aligner appliances of a system (e.g., of a series of shell aligner appliances) may have at least one of: pontics, attachment receiving wells, hooks, or precision cuts; in some examples, the one or more shell conversion appliances do not include pontics, attachment receiving wells, hooks, or precision cuts. In some examples the one or more shell conversion appliances do include pontics, attachment receiving wells, hooks, or precision cuts.

In any of the method and apparatuses described herein each appliance of a series of appliances (e.g., shell aligner apparatuses and/or shell conversion appliances) may be configured to be worn for more than a day (e.g., 2 days or more, 3 days or more, 4 days or more, 5 days or more, 6 days or more, 7 days or more, 1.5 weeks or more, 2 weeks or more, etc.). In general, the appliances may be configured to be applied and/or withdrawn or removed by the patient. For example, the appliances of the series of appliances may be configured to be worn for more than 3 days before wearing the next appliance of the series of appliances.

Using a conversion appliance may allow treatment without patient teeth movement one or both arches, which may be beneficial in certain scenarios. The use of conversion appliances may be incorporated one or more times during any point of treatment. For example, when used before the main active treatment (e.g., tooth movement stages), a patient may use a conversion appliance to become accustomed to wearing appliances for a less unpleasant experience during the active treatment. Using the conversion appliance may allow the patient’s bite to settle at the beginning of the treatment. For instance, the patient’s teeth may settle in their periodontal ligament (PDL) and minimize or mitigate impact on the temporomandibular joints.

When used after treatment, the conversion appliance may more smoothly transition the patient to a next portion of treatment. For example, after the patient has gone through treatment (e.g., primary order), the patient may require a second treatment (e.g., secondary order). The conversion appliance may aid the patient’s transition from the primary to the secondary order, or other treatments thereafter. Additionally or alternatively, the conversion appliance may aid the patient’s transition from treatment to retention (e.g., using a retainer or other appliance). For instance, the conversion appliance may allow an interarch relationship between the patient’s arches to finalize before going into retention. For example, the conversion appliance may allow using elastics, mandibular advancement, and/or other features to allow for further bite correction from Class II/Class III to Class I without the need to move the patient’s teeth. In such embodiments, the conversion appliance is worn by the patient and used with hooks and elastics to change the relationship between the arches without moving the teeth of the patient. Moreover, the patient may use the conversion appliance as temporary retention between two phases of treatment (e.g., phase 1 and phase 2), surgical treatment, or restorative treatment. Advantageously, the conversion appliance may be smoothly incorporated into the main treatment and may contain features on them, for an improved transition to retention.

In yet other scenarios, the patient may use the conversion appliance in the middle of treatment, such as between tooth movement stages. For example, the conversion appliance may aid the patient’s transition between stages. The patient’s treatment may continue without tooth movement as the patient wears and switches aligners according to the treatment schedule. In some examples, the patient may require additional tooth movement in one arch but not the other. Although the conversion appliance may be a pair of appliances (e.g., a pair of passive aligners), in such examples the conversion appliance may be a single appliance corresponding to the arch that does not require additional tooth movement. A given stage may require tooth movement in one arch using an appliance, during which the other arch may remain substantially unchanged by using a single passive aligner. In addition, the conversion appliance may be designed with attachments, precision cuts, pontics, bite ramps, etc., as requested by a dental professional or doctor.

A doctor may request one or more conversion appliances for a treatment using treatment planning software and/or treatment visualization software. In some examples, the software may automatically determine where in the treatment to place conversion appliances. A conversion appliance placement algorithm may consider one or more factors for placement. For example, the factors may include the treatment itself, preferences provided by the doctor (e.g., a number of conversion appliance stages placed at the beginning and/or end of treatment).

The doctor or other dental professional may manually modify the placement. The doctor may request conversion appliances at or between specific stages or tooth moments during treatment. The conversion appliance may be used for primary stages as described herein, for hooks and/or precision cuts during an intermediate stage as described herein, and/or as retainers toward the end of treatment as described herein. Thus, the doctor may request placement as well as features of conversion appliances. In some examples, the software may provide a visualization of the requests, such as on a timeline showing passive aligners on one or both arches.

In some examples, after finalizing the requested conversion appliances, the conversion appliances may be fabricated similar to appliances as described herein. After fabrication and delivery to the patient, the patient may wear the conversion appliance(s) as part of the schedule as prescribed by the doctor.

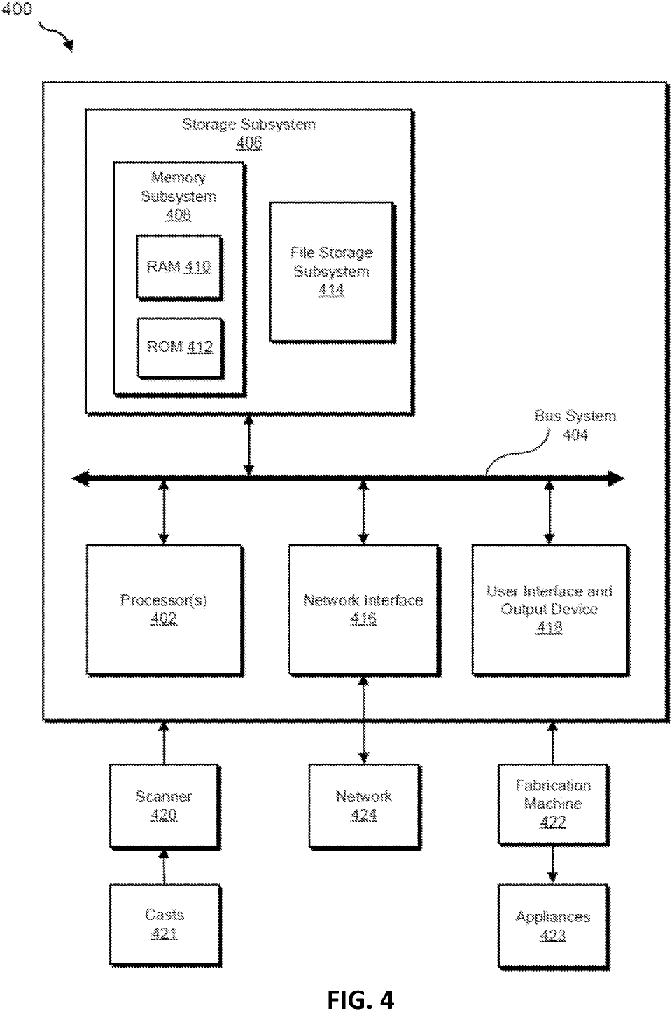

FIG. 4 is a simplified block diagram of a data processing system 400 that may be used in executing methods and processes described herein. The data processing system 400 typically includes at least one processor 402 that communicates with one or more peripheral devices via bus subsystem 404. These peripheral devices typically include a storage subsystem 406 (memory subsystem 408 and file storage subsystem 414), a set of user interface input and output devices 418, and an interface to outside networks 416. This interface is shown schematically as “Network Interface” block 416 and is coupled to corresponding interface devices in other data processing systems via communication network interface 424. Data processing system 400 can include, for example, one or more computers, such as a personal computer, workstation, mainframe, laptop, and the like.

The user interface input devices 418 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 406 maintains the basic required programming, including computer readable media having instructions (e.g., operating instructions, etc.), and data constructs. The program modules discussed herein are typically stored in storage subsystem 406. Storage subsystem 406 typically includes memory subsystem 408 and file storage subsystem 414. Memory subsystem 408 typically includes a number of memories (e.g., RAM 410, ROM 412, etc.) including computer readable memory for storage of fixed instructions, instructions and data during program execution, basic input/output system, etc. File storage subsystem 414 provides persistent (non-volatile) storage for program and data files and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 420 includes any means for obtaining a digital representation (e.g., images, surface topography data, etc.) of a patient’s teeth (e.g., by scanning physical models of the teeth such as casts 421, by scanning impressions taken of the teeth, or by directly scanning the intraoral cavity), which can be obtained either from the patient or from treating professional, such as an orthodontist, and includes means of providing the digital representation to data processing system 400 for further processing. Scanner 420 may be located at a location remote with respect to other components of the system and can communicate image data and/or information to data processing system 400, for example, via a network interface 424. Fabrication system or machine 422 fabricates appliances 423 based on a treatment plan, including data set information received from data processing system 400. Fabrication machine 422 can, for example, be located at a remote location and receive data set information from data processing system 400 via network interface 424.

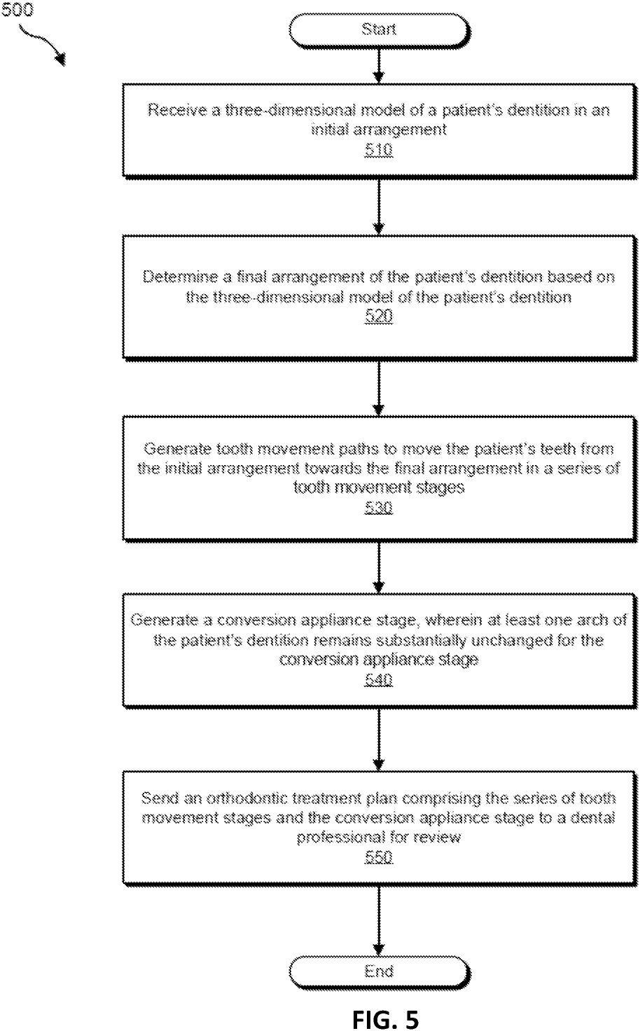

FIG. 5 presents a method 500 for generating a conversion appliance stage. As illustrated in FIG. 5, at step 510 one or more of the systems described herein may receive a three-dimensional (3D) model of a patient’s dentition in an initial arrangement. For example, data processing system 400 may receive a 3D model of the patient’s dentition from directly scanning the patient’s dentition using scanner 420, or scanning casts 421 of the patient’s dentition using scanner 420.

At step 520 one or more of the systems described herein may determine a final arrangement of the patient’s dentition based on the three-dimensional model of a patient’s dentition. For example, data processing system 400 may determine the final arrangement of the patient’s dentition based on the 3D model. In some examples, a doctor and/or other dental professional may provide additional parameters or inputs or manually modify the desired final arrangement.

At step 530 one or more of the systems described herein may generate tooth movement paths to move the patient’s teeth from the initial arrangement towards the final arrangement in a series of tooth movement stages. For example, data processing system 400 may generate the movement paths that may move the patient’s teeth from the initial arrangement to the final arrangement using the tooth movement stages.

The systems described herein may perform step 530 in a variety of ways. In one example, generating the tooth movements paths to move the patient’s teeth from the initial arrangement towards the final arrangement in a series of tooth movement stages may include generating a three-dimensional model based on the patient’s dentition for each of the series of tooth movement stages. These 3D models may be used for designing appropriate appliances for each stage and may also be used to provide visual references to the doctor.

In some examples, the tooth movement paths may include anterior-posterior corrections. For example, the anterior-posterior corrections may be at least 4 mm.

At step 540 one or more of the systems described herein may generate a conversion appliance stage. At least one arch of the patient’s dentition may remain substantially unchanged for the conversion appliance stage. For example, data processing system 400 may generate the conversion appliance stage automatically and/or with input from the doctor. As described herein, the conversion appliance stage may involve the patient wearing a conversion appliance that may not move the patient’s teeth of an arch relative to other teeth of the same arch or opposing arch and may keep one or both arches the same.

The systems described herein may perform step 540 in a variety of ways. In one example, data processing system 400 may determine whether to generate the conversion appliance stage. Determining whether to generate a conversion appliance stage may be based on one or more characteristics, such as at least one of the country of the patient, the doctor treating the patient, and/or the number of tooth movement stages.

In some examples, generating the conversion appliance stage may include generating an arrangement of the patient’s dentition for the conversion appliance stage. In addition, in some examples, generating the conversion appliance stage may include generating at least one of pontics, attachment receiving wells, hooks, or precision cuts for the conversion appliance stage.

In some examples, generating the conversion appliance stage may include generating a plurality of conversion appliance stages after the patient’s teeth of the first arch have completed movement towards the final arrangement. The patient’s dentition of the first arch may remain substantially unchanged. The patient’s teeth of the second arch may move towards the final arrangement during the conversation appliance stages.

In some examples, generating the conversion appliance stage may include generating a plurality of conversion appliance stages after the patient’s teeth of the first arch and the second arch have completed movement towards the final arrangement, wherein the patient’s dentition of the first arch and second arch remains substantially unchanged.

At step 550 one or more of the systems described herein may send an orthodontic treatment plan comprising the series of tooth movement stages and the conversion appliance stage to a dental professional for review. For example, data processing system 400 may send, via network 424, the treatment plan to the dental professional (e.g., a computing device connected to network 424).

In some examples, the dental professional may review, modify and/or finalize the treatment plan. Once approved, data processing system 400 may send the treatment plan to fabrication machine 422 for fabricating a series of dental appliances based on the orthodontic treatment plan, which may include at least one conversion appliance for the conversion appliance stage and one or more appliances for the series of tooth movement stages. Thus, fabrication machine 422 may fabricate appliances 423 according to the treatment plan.

Although method 500 is presented as a sequence of steps, in some examples, the steps of method 500 may be repeated as needed for treatment and/or transitions. Thus, certain steps may be repeated, and certain step may be performed in a different order.

As described herein, an orthodontic treatment system for a patient’s orthodontic treatment plan may include multiple pairs of orthodontic appliances or aligners. Each pair may correspond to a stage of the treatment plan for moving the patient’s teeth from a first arrangement towards a second arrangement (e.g., a desired arrangement for treatment). Each pair of appliances may include an appliance for a first arch (e.g., top arch) of the patient and an appliance for a second arch (e.g., bottom arch) of the patient. The appliance may include tooth receiving cavities. As described herein one of the pairs of appliances (e.g., an active treatment appliance) may be designed for tooth movement such that one or both appliances may have tooth receiving cavities shaped to move the patient’s teeth when worn by the patient. As described herein, another of the pairs of appliances may be a conversion appliance (e.g., passive treatment appliance) such that one or both appliances may have tooth receiving cavities that are shaped to be worn by the patient without moving the patient’s teeth. For example, the initial or first stage may include the conversion appliance for not moving the patient’s teeth and a second or subsequent stage may include the pair of appliances for moving the patient’s teeth. However, as further described herein, the conversion appliance may be used at any point during treatment, such as initial, final, and/or intermediate stages. Moreover, as described herein, additional conversion appliances may be used at any point during treatment.

In some examples, the appliances may have buccal and lingual sidewalls defining at least a portion of the tooth receiving cavities. The thickness of the sidewalls of the conversion appliance may be similar to the thickness of sidewalls of active treatment appliances, or it may be different. A conversion appliance may be fabricated of the same material as the other aligners of the treatment plan, or it may be fabricated from a different material.

In any of the apparatuses (e.g., systems, devices, etc.) and methods described herein, the conversion appliance(s) (aligners) may be distinguished from the other (tooth-moving) aligners. For example, the conversion appliance(s) may have a tooth-receiving cavity that is larger (on average) than the tooth receiving cavity of the tooth-moving aligners in the dental treatment plan. In some examples the conversion appliance(s) may have a smaller height on the buccal and/or lingual sides. In some examples the conversion appliance(s) may have a larger attachment coupling region for more loosely coupling to the one or more attachments. In some examples the conversion appliance(s) may have thinner walls, e.g., forming the buccal and/or lingual sides. Alternatively in some examples the conversion appliance(s) (aligners) may have approximately the same dimensions and appearance as the tooth-moving aligners in the treatment plan. In general, a treatment plan including one or more conversion appliances may be referred to as a modified treatment plan.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In any of the methods and apparatuses described herein the treatment plan may include pairs of aligners (e.g., upper arch and lower arch) or single (unpaired, upper arch only, lower arch only) sets of aligners. Conversion appliances may be included in either or both the upper and lower arches. In some examples the conversion appliances may be synchronously included, e.g., at the same stage(s) in the upper and lower arch. Alternatively or additionally, in some examples conversion appliances may be included asynchronously in the upper and lower arches; for example, a certain intermediate stage of the upper arch may include a conversion appliance while the same stage in the lower arch may include a tooth-moving appliance (aligner).

In some examples, all or a portion of example system 400 in FIG. 4 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 400 in FIG. 4 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 400 in FIG. 4 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 400 in FIG. 4 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 400 in FIG. 4 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 400 in FIG. 4 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

The terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/- 0.1% of the stated value (or range of values), +/- 1% of the stated value (or range of values), +/- 2% of the stated value (or range of values), +/- 5% of the stated value (or range of values), +/- 10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An orthodontic treatment system comprising a series of appliances, the series of appliances comprising:
a series of shell aligner appliances configured to be sequentially worn on a patient’s teeth to incrementally move a patient’s teeth from an initial tooth arrangement to a target tooth arrangement, further wherein each shell aligner appliance of the series of shell aligner appliances comprises a plurality of tooth-receiving cavities configured to hold the patient’s teeth and to apply a force to one or more of the patient’s teeth to move one or more of the patient’s teeth; and
one or more shell conversion appliances configured to worn as either a first appliance in the series of appliances or as an intermediate appliance in the series of appliances, wherein the one or more conversion shell appliances comprises a plurality of tooth-receiving cavities configured to hold the patient’s teeth without moving the patient’s teeth.

2. The system of claim 1, wherein the one or more shell conversion appliances are configured to be worn as intermediate appliance in the series of appliances.

3. The system of claim 1, wherein the one or more shell conversion appliances are formed of a different material than the shell aligner appliances of the series of shell aligner appliances.

4. The system of claim 1, wherein the plurality of tooth-receiving cavities of the one or more shell conversion appliances has an average volume that is greater than an average volume of the plurality of tooth-receiving cavities of any of the shell aligner appliances of the series of shell aligner appliances.

5. The system of claim 1, wherein the plurality of tooth-receiving cavities of the one or more shell conversion appliances are configured to be more loosely fitting to the patient’s teeth than the plurality of tooth-receiving cavities of the shell aligner appliances of the series of shell aligner appliances.

6. The system of claim 1, wherein the plurality of tooth-receiving cavities of the one or more shell conversion appliances have an average wall thickness that is less than the average wall thickness of the plurality of tooth-receiving cavities of the shell aligner appliances of the series of shell aligner appliances.

7. The system of claim 1, wherein the plurality of tooth-receiving cavities of the one or more shell conversion appliances have buccal and lingual sidewalls and the plurality of tooth-receiving cavities of the shell aligner appliances of the series of shell aligner appliances have buccal and lingual sidewalls, further wherein the average thickness of the buccal and lingual sidewalls of the shell conversion appliances is less than the average thickness of the buccal and lingual sidewalls of the shell aligner appliances of the series of shell aligner appliances.

8. The system of claim 1, wherein shell aligner appliances of the series of shell aligner appliances have at least one of: pontics, attachment receiving wells, hooks, or precision cuts, further wherein the one or more shell conversion appliances do not include pontics, attachment receiving wells, hooks, or precision cuts.

9. The system of claim 1, wherein each appliance of the series of appliances are configured to be worn for more than 3 days before wearing the next appliance of the series of appliances.

10. The system of claim 1, wherein the series of appliances are configured to be worn on the patient’s upper arch, and further comprising a second series of appliances configured to be worn on the patient’s lower arch, wherein the second series of appliances comprises a second series of shell aligner appliances and a second one or more shell conversion appliances.

11. The system of claim 10, wherein the second one or more shell conversion appliances correspond to a different position in the second series of appliances than a position of the one or more shell conversion appliances in the series of appliances.

12. A method comprising:
receiving a dental treatment plan comprising a plurality of treatment stages, wherein each stage comprises a shell aligner appliance configured to be sequentially worn in a specified treatment stage of the dental treatment plan, wherein each shell aligner appliance is configured to exert a force on one or more of the patient’s teeth in order to move the patient’s dentition from an initial arrangement towards a final arrangement;
generating a conversion appliance stage comprising a shell conversion appliance;
inserting the conversion appliance stage into the dental treatment plan to generate a modified dental treatment plan wherein the conversion appliance stage is between two treatment stages of the dental treatment plan, further wherein the shell conversion appliance is configured to exert a force of less than a dental movement threshold on the patient’s teeth when worn on the patient’s teeth so that the patient’s teeth remain substantially unchanged for the conversion appliance stage; and
sending the modified dental treatment plan to a dental professional for review.

13. The method of claim 12, further comprising transmitting the modified dental treatment plan for fabrication to form a series of dental appliances based on the dental treatment plan and including the shell aligner appliances and the conversion dental aligner.

14. The method of claim 12, further comprising receiving instructions from a dental professional indicating at which stage in the dental treatment plan to insert the conversion appliance stage.

15. The method of claim 12, wherein the dental movement threshold is 0.7 N.

16. The method of claim 12, wherein the dental movement threshold is 0.5 N.

17. The method of claim 12, wherein each shell aligner appliance of the dental treatment plan is configured to exert more than the dental movement threshold force on one or more of the patient’s teeth.

18. The method of claim 12, wherein the shell conversion appliance has a configuration that is substantially the same as a dental aligner corresponding to a stage of the dental treatment plan immediate before the conversion appliance stage in the modified dental treatment plan.

19. The method of claim 12, further comprising configuring the shell conversion appliance so that the shell conversion appliance is formed of a different material than the material of the shell aligner appliances.

20. The method of claim 12, further comprising configuring the shell conversion appliance so that the shell aligner appliance comprises a plurality of tooth-receiving cavities having an average volume that is greater than an average volume of a plurality of tooth-receiving cavities of any of the shell aligner appliances.

21. The method of claim 12, further comprising configuring the shell conversion appliance so that the shell aligner appliance comprises a plurality of tooth-receiving cavities that are configured to be more loosely fitting to the patient’s teeth than a plurality of tooth-receiving cavities of any of the shell aligner appliances.

22. The method of claim 12, further comprising configuring the shell conversion appliance so that the shell aligner appliance comprises a plurality of tooth-receiving cavities having an average wall thickness that is less than an average wall thickness of the plurality of tooth-receiving cavities of any of the shell aligner appliances.

23. The method of claim 12, further comprising configuring the shell conversion appliance to have buccal and lingual sidewalls having an average thickness that is less than the average thickness of buccal and lingual sidewalls of any of the shell aligner appliances.

24. The method of claim 12, wherein shell aligner appliances comprise at least one of: pontics, attachment receiving wells, hooks, or precision cuts, further wherein the one or more shell conversion appliances do not include pontics, attachment receiving wells, hooks, or precision cuts.

25. A non-transitory computing device readable medium having instructions stored thereon that are executable by a processor to cause a computing device to perform the method of:
receiving a dental treatment plan comprising a plurality of treatment stages, wherein each stage comprises a shell aligner appliance configured to be sequentially worn in a specified treatment stage of the dental treatment plan, wherein each shell aligner appliance is configured to exert a force on one or more of the patient’s teeth in order to move the patient’s dentition from an initial arrangement towards a final arrangement;
generating a conversion appliance stage comprising a shell conversion appliance;
inserting the conversion appliance stage into the dental treatment plan to generate a modified dental treatment plan wherein the conversion appliance stage is between two treatment stages of the dental treatment plan, further wherein the shell conversion appliance is configured to exert a force of less than a dental movement threshold on the patient’s teeth when worn on the patient’s teeth so that the patient’s teeth remain substantially unchanged for the conversion appliance stage; and
sending the modified dental treatment plan to a dental professional for review.

26. The non-transitory computing device readable medium of claim 25, wherein the instructions further comprise instruction for: transmitting the modified orthodontic treatment plan for fabrication to form the series of dental aligners including the conversion dental aligner.

27. The non-transitory computing device readable medium of claim 25, wherein the instructions further comprise instruction for receiving instructions from a dental professional indicating at which stage in the dental treatment plan to insert the conversion appliance stage.

28. The non-transitory computing device readable medium of claim 25, wherein the dental movement threshold is 0.7 N.

29. The non-transitory computing device readable medium of claim 25, wherein the dental movement threshold is 0.5 N.

30. The non-transitory computing device readable medium of claim 25, wherein each shell aligner appliance of the dental treatment plan is configured to exert more than the dental movement threshold force on one or more of the patient’s teeth.

31. The non-transitory computing device readable medium of claim 25, wherein the shell conversion appliance has a configuration that is substantially the same as a dental aligner corresponding to a stage of the dental treatment plan immediate before the conversion appliance stage in the modified dental treatment plan.

32. The non-transitory computing device readable medium of claim 25, wherein the instructions are further comprise configuring the shell conversion appliance so that the shell conversion appliance is formed of a different material than the material of the shell aligner appliances.

33. The non-transitory computing device readable medium of claim 25, wherein the instructions are further comprise configuring the shell conversion appliance so that the shell aligner appliance comprises a plurality of tooth-receiving cavities having an average volume that is greater than an average volume of a plurality of tooth-receiving cavities of any of the shell aligner appliances.

34. The non-transitory computing device readable medium of claim 25, wherein the shell aligner appliance comprises a plurality of tooth-receiving cavities that are configured to be more loosely fitting to the patient’s teeth than a plurality of tooth-receiving cavities of any of the shell aligner appliances.

35. The non-transitory computing device readable medium of claim 25, wherein the instructions are further comprise configuring the shell conversion appliance so that the shell aligner appliance comprises a plurality of tooth-receiving cavities having an average wall thickness that is less than an average wall thickness of the plurality of tooth-receiving cavities of any of the shell aligner appliances.

36. The non-transitory computing device readable medium of claim 25, wherein the instructions are further comprise configuring the shell conversion appliance to have buccal and lingual sidewalls having an average thickness that is less than the average thickness of buccal and lingual sidewalls of any of the shell aligner appliances.

37. The non-transitory computing device readable medium of claim 25, wherein shell aligner appliances comprise at least one of: pontics, attachment receiving wells, hooks, or precision cuts, further wherein the one or more shell conversion appliances do not include pontics, attachment receiving wells, hooks, or precision cuts.
